(19) United States
(12) Patent Application Publication
(10) Pub. No.: US 2013/0220364 A1
(43) Pub. Date: Aug. 29, 2013

(54) REACTOR BOX CHAMBER CLEANING USING MOLECULAR FLUORINE

(71) Applicants: Jean-Charles Cigal, Bielefeld (DE); Stefan Petri, Bielefeld (DE); Paul Alan Stockman, Hillsborough, NJ (US); Oliver Knieling, Bielefeld (DE)

(72) Inventors: Jean-Charles Cigal, Bielefeld (DE); Stefan Petri, Bielefeld (DE); Paul Alan Stockman, Hillsborough, NJ (US); Oliver Knieling, Bielefeld (DE)

(21) Appl. No.: 13/700,166

(22) PCT Filed: Aug. 11, 2011
(86) PCT No.: PCT/US11/47349

§ 371 Date: May 14, 2013

Related U.S. Application Data
(60) Provisional application No. 61/376,778, filed on Aug. 25, 2010.

(51) Int. Cl. B08B 7/00

(52) U.S. Cl. CPC B08B 7/00
USPC 134/1; 156/345.1

(57) ABSTRACT

Methods and apparatus for the cleaning reactor box chambers using molecular fluorine as the cleaning material. The molecular fluorine is dissociated in-situ in the chamber using the chamber RF power source.

### FIELD OF THE INVENTION

The present invention relates to new methods for the cleaning reactor box chambers and to apparatus therefore.

### BACKGROUND OF THE INVENTION

Plasma deposition chambers, also known as “reactor boxes” or “plasma boxes” are used to deposit thin films primarily for photovoltaic applications and devices. These reactor boxes are particularly useful for the formation of thin films for solar panels, TFT display panels and plasma display panels. For example, a reactor box is described in U.S. Pat. No. 4,798,739 (Schmitt), as having a low-pressure tank placed within an air-tight chamber having a lower pressure than that of the tank. This reactor box is for plasma-depositing onto at least two substrates spaced apart in a substantially parallel relationship in the tank. To effect decomposition of the gas reagents in the tank, at least one perforated polarized plasma generating electrode is interposed between the substrates.

Another reactor box arrangement is shown in U.S. Pat. No. 5,275,709 (Anderle et al) that relates to stacks of processing chambers each having an opening connected with an elevator chamber to allow for more efficient movement of substrates between the chambers. A single load lock chamber is associated with the stacked chambers opposite the connection with the elevator chamber. One advantage of this system is the smaller equipment footprint occupied by the stacked processing chambers.

U.S. Pat. No. 7,244,086 (Ostermann et al) shows improvements to the Anderle et al system. In particular, Ostermann et al maintains the space advantages of the tower structure described by Anderle et al and adds flexibility to the system by utilizing a dual tower arrangement wherein more than one load lock can be utilized. This arrangement is advantageous in providing more alternatives for processing with faster cycle times.

All of the above systems utilize plasma enhanced chemical vapor deposition (PECVD) methods to deposit thin films. The thin films are deposited from a gas state to a solid state onto the surface of a substrate by injecting precursor reacting gases into the reactor chamber and then activating the gases using a plasma created by radio frequency (RF) power. However, the deposition processes also leave deposits on the reactor chamber walls and internal equipment, e.g. the RF power source that must be periodically cleaned.

Known methods for cleaning reactor box chambers include in-situ activation of a cleaning gas containing fluorine, such as NF₃, SF₆, C₂F₆, or other fluoro carbon molecules. The cleaning gas is introduced into the chamber along with oxygen and argon and a plasma is ignited using the chamber RF power source to create fluorine ions and radicals that react with the deposits on the sidewalls and parts of the chamber. However, the energy required to dissociate such fluorine containing molecules is high, therefore requiring an energy source in the chamber, such as RF power. For example, the S—F bonds of SF₆ have dissociation energy exceeding 300 kJ/mol on average. The available energy available from the chamber RF source is often less than necessary and must often be limited because of the risk of arcing. Because of these limitations, full dissociation of the cleaning gas, e.g. SF₆ or NF₃ is not achieved leading to low cleaning efficiency.

Another chamber cleaning method uses a remote plasma source to activate the fluorine containing cleaning gas. The most commonly used gas for this method is NF₃. In this method, the cleaning gas first passes through a plasma source situated outside of the reactor chamber for dissociation o the cleaning gas. The radicals then enter the chamber to perform the cleaning. Remote plasma activation can provide higher gas dissociation than in-situ activation thereby improving cleaning efficiency. However, using a remote plasma source requires additional equipment that adds considerably to operations cost and complexity. Further, gas flow is often limited by the parameters of the remote plasma source thereby increasing cleaning time and cost. Efficient implementation of a remote plasma activation method is difficult because the remote plasma source usually has to be placed relatively far from the reactor chamber, particularly when the processing chambers are provided in stacks or towers in a single vacuum chamber. In such an arrangement, the radicals formed in the remote plasma source have a higher tendency to recombine, e.g. by wall recombination, before entering the chamber, thus reducing cleaning efficiency.

Fluorine containing cleaning gases like SF₆ and NF₃ have potentially damaging environmental effects. In particular, these gases have high global warming potentials. Because these gases are not fully dissociated, a significant percentage of the gas passes through the system and it has been documented that despite efforts to contain and abate these gases, about ten percent of the gas escapes to the atmosphere. Further, the fluorine containing gases contain other atomic constituents, e.g. nitrogen and sulfur that do not contribute to the chamber cleaning. Finally, the multiple reaction pathways available to fluorine containing gases, which especially tend to dominate at commercially viable pressures and activation powers, result in inefficient use of these compounds for chamber cleaning. Therefore, the use of these gases results in low mass efficiency.

There is a need in the art for improvements to apparatus and methods for the cleaning reactor box chambers.

### SUMMARY OF THE PRESENT INVENTION

The present invention provides improved methods and apparatus for cleaning reactor box chambers that overcome the disadvantages of the prior art methods and apparatus. In particular, the present invention utilizes molecular fluorine for cleaning of the chamber.

### BRIEF DESCRIPTION OF THE DRAWINGS

FIG. 1 is a graph showing the effect of clean rate for a reactor box chamber based on flow rate of the cleaning gas for both molecular fluorine and SF₆.

FIG. 2 is a graph showing the influence of plasma power on clean time for the use of molecular fluorine in accordance with the present invention.

### DETAILED DESCRIPTION OF THE INVENTION

The present invention uses molecular fluorine for reactor box chamber cleaning. In present invention shows that fluorine radicals created by dissociation of molecular fluorine is a very efficient cleaning gas. The dissociation energy required for molecular fluorine is relatively low and can be provided by the RF power source already in place within the reactor box chamber, i.e. the RF power source used for dissociation of the deposition precursors. No remote plasma activation is necessary and therefore no additional equipment is needed.

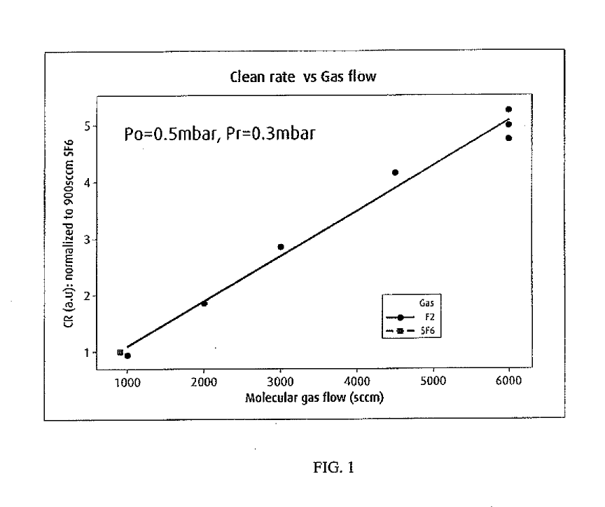

FIG. 1 is a graph showing the effect of clean rate for a reactor box chamber based on flow rate of the cleaning gas for both molecular fluorine and SF₆. In particular, FIG. 1 shows that molecular fluorine will efficiently clean chambers that are based on the concept of a reactor enclosed in a vacuum chamber, e.g. the reactor box or plasma box chamber, such as those available from Oerlikon. In these types of chambers, the outer vacuum chamber has a predetermined back pressure based on the cleaning process and a pressure differential set between the reactor pressure and the backpressure. FIG. 1 shows that a much larger processing window can be used when using molecular fluorine as compared to SF₆, therefore allowing a wider range of gas flow and pressure in the chamber. This allows for optimization of the cleaning process as different cleaning regimes can be defined with backpressures ranging between 0.1 mbar and 10 mbar, preferably between 0.25 mbar and 2.5 mbar and more preferably between 0.5 mbar and 2 mbar. Reactor pressures between 10% and 200% of the backpressure were tested and found generally acceptable. Preferably, the reactor pressure is set between 10% and 90% of the backpressure.

Because of the relatively low dissociation energy of molecular fluorine, full dissociation can be achieved in-situ. This not only improves gas utilization, but also provides greater cleaning efficiency and shorter cleaning cycle times. As noted above, full dissociation of fluorine containing compounds, such as SF₆ and NF₃ can not be accomplished in-situ, therefore requiring additional energy be provided from a remote plasma source. Even using such remote plasma sources does not generally result in full dissociation of the fluorine containing compounds.

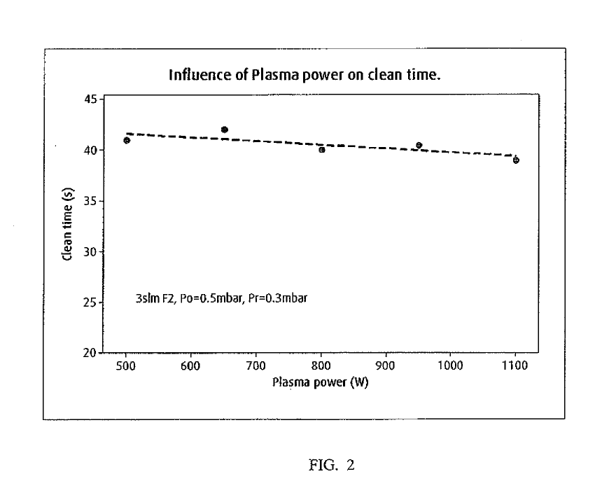

FIG. 2 is a graph showing the influence of plasma power on clean time for the use of molecular fluorine in accordance with the present invention. In particular, FIG. 2 shows that increasing RF power did not significantly change the chamber cleaning time when using molecular fluorine. This indicates that even at low RF energy, the molecular fluorine is fully dissociated.

The present invention using molecular fluorine for the cleaning gas provides superior cleaning efficiency and rates over the fluorine containing compounds used in the prior art. Further, the present invention offers several other advantages. In particular, when using molecular fluorine there are fewer limitations on gas flow and chamber pressure enabling wider cleaning processing windows. This means that the cleaning gas is better utilized and exhibits faster cleaning process cycle times. In addition, since there are no unused atomic constituents in molecular fluorine, much greater mass efficiency is obtained by the present invention. Molecular fluorine results in a 20% increase in mass efficiency over the use of NF₃ and an effective 74% increase in mass efficiency over the use of SF₆ (where decomposition usually stops at SF₄ which then reacts with O₂ to prevent deposition of sulfur in the chamber).

A further advantage of using molecular fluorine is that it can be fully dissociated in-situ so that a remote plasma source is not necessary thus reducing operational complexity and cost. Because no remote plasma source is necessary in accordance with the present invention, there is no constraint on chamber or system design and the distance of the remote plasma source from the chamber. In particular, there is no risk of recombination of dissociated cleaning gas when employing the present invention. Further, when using molecular fluorine according to the present invention it is not necessary to mix the fluorine with any plasma enhancing gases, such as oxygen or argon, rather the fluorine can be used neat.

Moreover, the present invention has a very low environmental impact as the molecular fluorine is more easily fully dissociated and molecular fluorine has no global warming potential. This allows the present invention to eliminate complex containment and abatement systems that are required when using fluorine containing gases.

The above discussion of the present invention focuses on the use of molecular fluorine for reactor box chamber cleaning. However, the present invention may also be useful for cleaning of silicon containing films, including silicon (amorphous, microcrystalline and crystalline) silicon oxides, silicon nitrides, silicon oxy-nitrides, silicon carbides, silicon carbonitrides, etc.

It is anticipated that other embodiments and variations of the present invention will become readily apparent to the skilled artisan in the light of the foregoing description, and it is intended that such embodiments and variations likewise be included within the scope of the invention as set out in the appended claims.

What is claimed:

1. A methods for of cleaning a reactor box chamber comprising:
introducing molecular fluorine to the chamber;
dissociating the molecular fluorine to create fluorine radicals;
allowing the fluorine radicals to react with unwanted deposits in the chamber; and
removing the resultant gas from the chamber.

2. The method according to claim 1 wherein dissociating the molecular fluorine comprises exposing the molecular fluorine to an RF power source.

3. The method according to claim 1 wherein the chamber is enclosed in a vacuum chamber having a backpressure and the method further comprises carrying out the method at a backpressure between 0.1 mbar and 10 mbar.

4. The method according to claim 3 wherein the backpressure is between 0.25 mbar and 2.5 mbar.

5. The method according to claim 3 wherein the backpressure is between 0.5 mbar and 2 mbar.

6. The method according to claim 3 wherein the chamber pressure is between 10% and 200% of the backpressure.

7. The method according to claim 6 wherein the chamber pressure is between 10% and 90% of the backpressure.

8. An apparatus for cleaning a reactor box chamber comprising:
a reactor box chamber; and
a source of molecular fluorine communicating with the reactor box chamber.

9. The apparatus according to claim 8 further comprising a vacuum chamber enclosing the reactor box chamber.
